(19) United States
(12) Patent Application Publication
(10) Pub. No.: US 2011/0249924 A1
(43) Pub. Date: Oct. 13, 2011

(54) PILLOW BLOCK FOR A SEGMENTED MEDIA-LUBRICATED PLAIN BEARING

(75) Inventors: Benjamin Holstein, Heidenheim (DE); Norman Perner, Neu-Ulm (DE); Spiegel Klaus, Dusseldorf (DE)

(73) Assignee: VOITH PATENT GMBH, Heidenheim (DE)

(21) Appl. No.: 13/128,300

(22) PCT Filed: Dec. 14, 2009
(86) PCT No.: PCT/EP09/08935

§ 371 Date: May 9, 2011

(30) Foreign Application Priority Data
Dec. 15, 2008 (DE) 10 2008 061 912.4

(51) Int. Cl. F16C 33/10

(52) U.S. Cl. 384/286

(57) ABSTRACT

The invention relates to a pillow block (1) for a segmented, media-lubricated plain bearing having a base body (2) comprising a contact surface (10); a sliding lining disposed on the contact surface (10) and forming a sliding surface (13), comprising a polymer material and associated with a center of area (12); characterized in that the material thickness of the sliding lining (3) in the direction of the surface normals of the sliding surfaces (13) in the unloaded state at the edge of the sliding surface (13) is greater than at the center of area (12), wherein the local differences in material thickness of the sliding lining (3) are formed by the surface profile of the contact surface (10) of the base body (2), and the contact surface (10) of the base body (2) comprises a convex profile or a raised area in the form of a level base in the region of the center of area (12).

The invention relates to a pillow block for a segmented, media-lubricated plain bearing, especially water-lubricated, seawater-compatible plain bearing.

Plain bearings with sufficient resistance to seawater are necessary for maritime vehicles, e.g. for forming stern tube bearings or for the bearing of revolving units such as underwater power plants or tidal power plants for example. Hydrodynamic plain bearings with water lubrication have proven to be sufficiently stable. They are preferably arranged in such a way that a plurality of pillow blocks is guided with a sliding lining comprising an elastomer against a mating running surface with a higher hardness and a higher modulus of elasticity. As a result of this soft/hard pairing, a sturdy bearing is produced which is insensitive to deformation and which is resistant to sediments when using ambient water as a lubricating medium.

At least one of the sliding surfaces of the bearing is arranged in a segmented manner, especially for the arrangement of large-size bearings of the kind mentioned above. Reference is hereby made to DE 28 02 098 A1 by way of example. Pillow blocks are used which have a base body which carries the actual sliding lining, which on its part consists of a plain bearing material which is suitable for the application. A material is chosen for this purpose which is as elastic as possible in order to ensure good adjustment to a mating running surface. This leads to the difficulty that a defined distance of the bearing gap cannot be maintained for all operating conditions.

The invention is based on the object of providing an improved pillow block for a segmented, media-lubricated plain bearing which overcomes the disadvantages as mentioned above and ensures an improved distribution of the lubricating film pressures on the plain bearing surface under all operating conditions.

In order to achieve this object the inventors have recognised at first that a concave deflection occurs in the central region for a lubricating film that is building up hydrodynamically and for the resulting parabolic pressure development for elastic sliding linings. This leads to an expansion of the bearing gap and a drop in the pressure distribution in the central region of the sliding surface.

This undesirable effect is counteracted in accordance with the invention in such a way that the thickness of the material of the sliding lining in the direction of the surface normals of the sliding surface is adjusted to the lubricating film pressure occurring during operation. In the regions of high pressure which are disposed around the surface centre of the sliding surface, a reduced thickness of the material is used, whereas the edge regions have a large thickness of the material. The profile of the sliding surface is preferably maintained, which typically corresponds to that of the mating running surface. The adjustment of the material thickness of the sliding lining occurs through a respective profiling of the bearing surface on the base body which is opposite of the rear side of the sliding lining. It is possible to use a stepped contour, but in the simplest of cases an elevated base is provided the central region of the bearing surface of the base body. A more precise adjustment can be achieved by a progression of the bearing surface which is stepped several times or is convex.

In the regions in which an especially high lubricating film pressure can occur it is possible to provide a profile of the sliding surface which remains substantially constant during operation as a result of the supporting effect by the base body and the reduced compressibility of the same as a result of the thinning of the sliding lining. The bearing gap in the bearing and, as a consequence, the lubricating film thickness on the sliding surfaces of the pillow blocks are kept substantially constant.

The invention will be explained below in closer detail by reference to embodiments and illustrations in the drawings, which show in detail as follows:

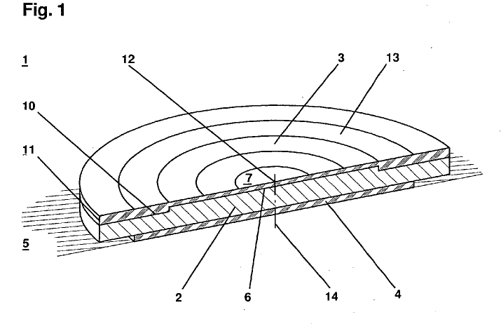

FIG. 1 shows a spatial section through a pillow block in accordance with the invention;

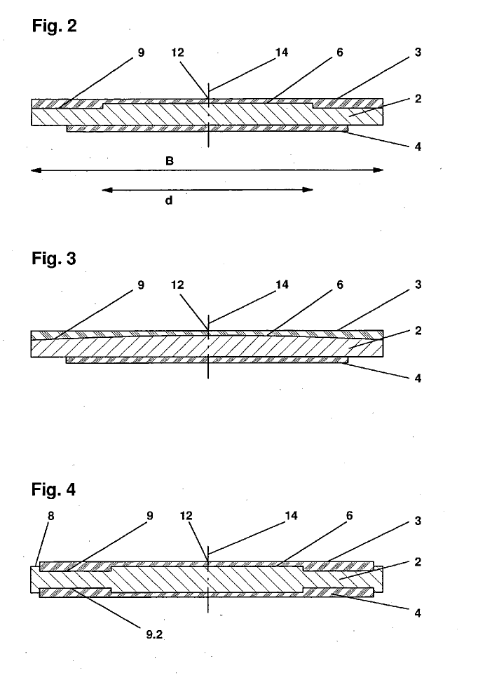

FIG. 2 shows a cross-sectional view of the pillow block of FIG. 1;

FIG. 3 shows an alternative configuration of the pillow block in accordance with the invention in a cross-sectional view;

FIG. 4 shows a further alternative of an embodiment of the pillow block in accordance with the invention in a cross-sectional view.

FIG. 1 shows a spatial section for an embodiment of a pillow block 1 in accordance with the invention. A circular pillow block 1 with a planar guiding surface has been chosen for the illustrated embodiment.

Within the scope of the invention, pillow blocks 1 with rectangular, elliptical or triangular shapes for example which deviate from the circular shape are possible. Furthermore, the profile of the sliding surface 13 can deviate from the illustrated arrangement which is planar in the unloaded state. It is possible that the pillow block 1 has a progression which bulges in a convex manner on the sliding surface 13 for a similarly planar mating running surface and is therefore arranged in a spherical way. Furthermore, the progression of the sliding surface 13 can be adjusted to a non-planar shape on a mating running surface. This will especially be the case in a radial plain bearing for guiding the shaft of a machine or the like.

In accordance with the invention, the sliding lining 3 has a locally varying material thickness in the direction of the surface normal of the sliding surface 13. This is achieved in the present embodiment in such a way that the surface profile of the bearing surface 10 of the base body 2 on which the sliding lining 3 is arranged is not provided with a planar arrangement but has a lifted region in form of a base 6 towards the centre 12 of the surface which coincides with the piercing point of the central axis 14 in the present embodiment.

For the illustrated embodiment, said base 6 has a diameter which corresponds 50% to 70%, especially preferably approx. 60%, to the diameter of the base body 2. For the purpose of a non-circular arrangement of the base body 2 (not shown) it is necessary to adjust the extension of the base 6, which in this case will also not be chosen to be circular, in a respective relative way in relation to the transversal dimensions of the base body 2.

A section of the sliding lining 3 with reduced material thickness is obtained in a central region 7 around the surface centre 12 by the profile of the bearing surface 10 of the base body 2. For the present embodiment, the material thickness of the sliding lining 3 in the region of the base 6 has been chosen in such a way that it corresponds to 50% of the material thickness of the sliding lining 3 outside of the region of the base 6 which extends towards the edge 11 of the base body 2. This is shown in the cross-sectional view of FIG. 2, with the transversal extension of base 6 being designated with d and assuming in the present case 60% of the diameter B of the entire base body 2.

An alternative embodiment is shown in FIG. 3. Instead of a base 6, at least one part is shaped in a convex manner, presently the entire bearing surface 10. A sliding lining is obtained again in the region around the central axis 14 which is reduced with respect to the material thickness.

A further alternative embodiment is shown in FIG. 4. A turned groove 9 is provided on the upper side of the base body 2 which forms the bearing surface 10. An edge 8 is obtained by this measure which laterally supports the sliding lining 3 and the base 6 which was explained in connection with FIG. 2 and which leads to a reduced material thickness of the sliding lining 3 in the central region of the pillow block 1.

The sliding lining 3 comprises a polymer material and preferably an elastomer. Possible materials for the sliding lining with sufficient resistance to dry running are Buna® and Orkot®. The sliding lining forms a soft/hard pairing with the mating running surface (not shown in closer detail), with the modulus of elasticity of the sliding lining 3 being approx. 1% of the modulus of elasticity for the mating running surfaces for a preferred embodiment. The mating running surfaces can be steel parts for example. Such a pairing of materials allows forming a water-lubricated plain bearing which is compatible with the use of seawater as a lubricant. Accordingly, the pillow block in accordance with the invention can be used for a media-lubricated plain bearing which is suitable for bearing the revolving parts of an underwater power plant or for forming a stern tube bearing of the propeller shaft of a water craft.

On the basis of the soft/hard pairing of the bearing as explained above, the arrangement of the pillow block in accordance with the invention prevents a concave deflection in the central region of the sliding surface 13 during operation as a result of the lubricant pressure. Accordingly, no undesirable expansion of the bearing gap occurs in this region. The base body 2, which has a higher modulus of elasticity than the sliding lining 3 and is made of steel, bronze, glass or wood or any other composite material for example, prevents the mentioned deflection in the central region. In the boundary region of the sliding lining 3 which is loaded to a lower extent it is possible to choose a higher material thickness in order to obtain a running layer which is as elastic as possible and which adjusts especially well to the shape of a mating running surface which might be subjected to deformation in operation. The material thickness of the lubricant film can accordingly be kept as constant as possible, so that a large plain bearing is obtained with high bearing capacity.

The sliding lining is materially connected with the bearing surface 10 of the base body 2 preferably by gluing, moulding on or the like. In addition or alternatively, the sliding lining 3 can be fastened to the base body at individual suspension points, e.g. by means of a screw connection, or the bearing surface 10 of base body 2 comprises a pattern of receivers in which the sliding lining 3 will engage for secure fastening. In addition, the edge 8 as shown in FIG. 4 can be provided as a lateral boundary of the sliding lining 3.

An elastic support 4 is disposed beneath the base body 2 of pillow block 1 for the purpose of an advantageous embodiment. It can preferably be arranged in a planar manner and, for the purpose of a simple construction, consist of the material of the sliding lining which is provided with such sufficient thickness between the base body 2 and the bearing 5 that a certain tilting of the pillow block 1 against the bearing 5 is enabled. An especially preferred embodiment for the elastic support 4 is shown in FIG. 4. The bottom side of the base body 2 is provided with a bottom turned groove 9.2, so that the material thickness of the planar arranged elastic support 4 is larger in the boundary regions of base body 2 than compared with the central region.

Further embodiments are possible within the scope of the following claims. It is especially possible to arrange the sliding surface 13 in a perforated manner and to provide the same with grooves for improving the guidance of the lubricant or a supply of lubricant from the rear side.

### LIST OF REFERENCE NUMERALS

1 Pillow block
2 Base body
3 Sliding lining
4 Elastic support
5 Bearing
6 Base
7 Central region
8 Edge
9 Turned groove
9.2 Bottom turned groove
10 Bearing surface
11 Edge
12 Centre of surface
13 Sliding surface
14 Central axis

1. A pillow block for a segmented, media-lubricated plain bearing, comprising
a base body comprising a bearing surface;
a sliding lining which is arranged on the bearing surface, forms a sliding surface, comprises a polymer material and is associated with a centre of the surface; characterized in that
the material thickness of the sliding lining is larger in the direction of the surface normals of the sliding surface in the unloaded state at the edge of the sliding surface than in the centre of the surface, with the local differences in material thickness of the sliding lining being formed by the surface profile of the bearing surface of the base body and the bearing surface of the base body having a convex profile or an elevated region in form of a planar base in the region of the centre of the surface.

2. A pillow block according to claim 1, characterized in that in the unloaded state the sliding surface has a profile adjusted to the mating sliding surface of the plain bearing.

3. A pillow block according to claim 1, characterized in that the base body has a turned groove on the side of the bearing surface in the boundary region, so that an edge laterally delimiting the sliding lining and a base are obtained in the region of the centre of the bearing surface.

4. A pillow block according to claim 1, characterized in that the base has a circular cross section with the centre of the surface as the central point and a radius of 50 to 70% of the smallest distance of the centre of the surface to the edge.

5. A pillow block according to claim 1, characterized in that the sliding lining consists of an elastomer.

6. A pillow block according to claim 1, characterized in that the sliding lining can have a lower hardness than the base body.

7. A pillow block according to claim 1, characterized in that the pillow block further comprises an elastic support for contact on a bearing.

8. A pillow block according to claim 7, characterized in that the elastic support consists of the material of the sliding lining.

9. A pillow block according to claim 7, characterized in that the elastic support in the direction of the edge of the base body has a larger thickness in comparison with the region around the central axis.

10. A pillow block according to claim 1, characterized in that the base body has a turned groove on the upper side in the boundary region and a bottom turned groove on the bottom side in the boundary region, with the sliding lining and the elastic support having in these regions a larger thickness in comparison with the adjacent regions.

11. A pillow block according to claim 2, characterized in that the base body has a turned groove on the side of the bearing surface in the boundary region, so that an edge laterally delimiting the sliding lining and a base are obtained in the region of the centre of the bearing surface.

12. A pillow block according to claim 3, characterized in that the base has a circular cross section with the centre of the surface as the central point and a radius of 50 to 70% of the smallest distance of the centre of the surface to the edge.

13. A pillow block according to claim 2, characterized in that the base has a circular cross section with the centre of the surface as the central point and a radius of 50 to 70% of the smallest distance of the centre of the surface to the edge.

14. A pillow block according to claim 2, characterized in that the sliding lining can have a lower hardness than the base body.

15. A pillow block according to claim 3, characterized in that the sliding lining can have a lower hardness than the base body.

16. A pillow block according to claim 2, characterized in that the sliding lining can have a lower hardness than the base body.

17. A pillow block according to claim 2, characterized in that the base body has a turned groove on the upper side in the boundary region and a bottom turned groove on the bottom side in the boundary region, with the sliding lining and the elastic support having in these regions a larger thickness in comparison with the adjacent regions.

18. A pillow block according to claim 3, characterized in that the base body has a turned groove on the upper side in the boundary region and a bottom turned groove on the bottom side in the boundary region, with the sliding lining and the elastic support having in these regions a larger thickness in comparison with the adjacent regions.

19. A pillow block according to claim 4, characterized in that the base body has a turned groove on the upper side in the boundary region and a bottom turned groove on the bottom side in the boundary region, with the sliding lining and the elastic support having in these regions a larger thickness in comparison with the adjacent regions.

20. A pillow block according to claim 6, characterized in that the base body has a turned groove on the upper side in the boundary region and a bottom turned groove on the bottom side in the boundary region, with the sliding lining and the elastic support having in these regions a larger thickness in comparison with the adjacent regions.
